(19) United States
(12) Patent Application Publication
(10) Pub. No.: US 2014/0079072 A1
(43) Pub. Date: Mar. 20, 2014

(54) INDIRECT COMMUNICATION IN SECONDARY VIRTUAL LOCAL ACCESS NETWORKS

(71) Applicant: Dan Simcha Shechter Gelles, Kfar Yona (IL)

(72) Inventor: Dan Simcha Shechter Gelles, Kfar Yona (IL)

(21) Appl. No.: 13/786,490

(22) Filed: Mar. 6, 2013

Related U.S. Application Data
(60) Provisional application No. 61/609,369, filed on Mar. 12, 2012.

(51) Int. Cl. H04L 12/931; H04L 29/12

(52) U.S. Cl. CPC H04L 49/354; H04L 61/103
USPC 370/395.53

(57) ABSTRACT

A method that may include: Receiving, by a network appliance, a request, from a source host, to resolve a network layer address of a target host into a link layer address of the target host. The source host belongs to a source secondary VLAN, the target host belongs to a target secondary VLAN and both source and secondary VLANs are coupled to a primary VLAN that is coupled to a primary VLAN gateway. Determining whether to facilitate indirect communication between the target and source hosts. If so (YES) then generating, by the network appliance, a response that resolves the network layer address of the target host to a link layer address of the primary VLAN gateway; and sending the response to at least the source host.

### RELATED APPLICATIONS

This application claims priority from U.S. provisional patent 61/609,369 filing date Mar. 12, 2012 which is incorporated herein by reference.

### BACKGROUND

Private virtual local access network (VLAN) is a technology used to separate between hosts on the same internet protocol (IP) version four (IPv4) or IP version six (IPv6) subnets.

Private VLAN is implemented on Ethernet switches (Multi port bridge), either real (such as Cisco™, Juniper™, etc) or virtual (such as VMWare™ vDS, Cisco Nexus 1000V™ and Hyper-V).

A subnet, which is called a Primary VLAN, is separated to Secondary VLANs.

There are two types of secondary VLANS:
a. Community VLANs, where hosts inside that VLAN can communicate with each other but can't communicate with hosts on a different secondary VLAN.
b. Isolated VLANs, where hosts can't communicate with any other host in the same Secondary VLAN or with hosts on other Secondary VLANs

Some ports on a switch are called promiscuous ports, where hosts attached to these ports can communicate with any host, no matter on what secondary VLAN they belong to. Usually, Firewalls are connected to such ports.

Hosts of each Primary VLAN are on the same IPv4/IPv6 subnet, which means that they will try to reach each other directly. Hosts on different Secondary VLANs or on an Isolated VLAN can't communicate directly.

For hosts of different Secondary VLANs or of an Isolated VLAN to communicate with each other, they must be manually configured with a static route to reach each other via the Firewall or any other gateway which is attached to a promiscuous port. There is a growing need to provide a system, a method and a computer readable medium for facilitating indirect communication between hosts. Without manual host configurations.

### SUMMARY

There may be provided a method for facilitating communication between hosts coupled to a primary virtual local area network (VLAN), the method comprises: receiving, by a network appliance, a request, from a source host, to resolve a network layer address of a target host into a link layer address of the target host; wherein the source host belongs to a source secondary VLAN and wherein the target host belongs to a target secondary VLAN; wherein the target secondary VLAN and the source secondary VLAN are coupled to the primary VLAN; wherein the primary VLAN comprises a primary VLAN gateway; determining whether to facilitate indirect communication between the target and source hosts; wherein if it is determined to facilitate indirect communication between the source and target host then: generating, by the network appliance, a response that resolves the network layer address of the target host to a link layer address of the primary VLAN gateway; and sending the response to at least the source host.

The source secondary VLAN may be the target secondary VLAN.

The source secondary VLAN may be configured as an isolated VLAN and wherein the method comprises determining to facilitate indirect communication between the source and target hosts.

The source secondary VLAN may be configured as a community VLAN and wherein the method comprises determining not to generate the response.

The method may include determining not to generate the response if the source and target hosts are allowed to directly communicate with each other.

The source secondary VLAN may differ from the target secondary VLAN.

The method may include determining to facilitate indirect communication between the source and target hosts if at least one of the primary and secondary hosts is configured as a community VLAN or as an isolated VLAN.

The method may include learning a mapping between network layer address and the link layer address of the primary VLAN gateway.

The method may include learning a mapping between network layer addresses and link layer addresses of hosts and the host's association to a secondary VLAN.

If it is determined to facilitate indirect communication between the source and target host then the method may include generating an updated request that comprises the network layer address of the target host and the link layer address of the primary VLAN gateway; and sending the updated request to at least the source host.

The method may include receiving a notice from the primary VLAN gateway notifying of a change in the link layer address of the primary VLAN gateway; updating the link layer address of the primary VLAN gateway and determining not to send a response to the notice.

The method may include sending a request to identify the target host, if the network application is unaware of the identity of the target host; and awaiting to receive an identifying response from the target host before determining whether to facilitate indirect communication between the target and source hosts.

The method may include ignoring requests to resolve the network layer address of the target host into the link layer addresses of the target host until a reception of the identifying response.

The method may include analyzing the request to detect request errors in response to configurations of the source and target secondary VLANs.

The request may be address resolution protocol (ARP) compliant.

The request may be network discovery protocol (ICMPv ND) compliant.

The network layer address of the target host may be internet protocol compliant.

The link layer address of the target host may be Ethernet compliant.

There may be provided a non-transitory computer readable medium that stores instructions for (that cause a computerized system to execute a method that includes): receiving, by a network appliance, a request, from a source host, to resolve a network layer address of a target host into a link layer address of the target host; wherein the source host belongs to a source secondary virtual local area network (VLAN) and wherein the target host belongs to a target secondary VLAN; wherein the target secondary VLAN and the source secondary VLAN are coupled to a primary VLAN; wherein the primary VLAN comprises a primary VLAN gateway; determining whether to facilitate indirect communication between the target and source hosts; wherein if it is determined to facilitate indirect communication between the source and target host then: generating, by the network appliance, a response that resolves the network layer address of the target host to a link layer address of the primary VLAN gateway; and sending the response to at least the source host.

A computerized system, may include a communication module and a processor; wherein the communication module is arranged to receive a request, from a source host, to resolve a network layer address of a target host into a link layer address of the target host; wherein the source host belongs to a source secondary virtual local area network (VLAN) and wherein the target host belongs to a target secondary VLAN; wherein the target secondary VLAN and the source secondary VLAN are coupled to a primary VLAN; wherein the primary VLAN comprises a primary VLAN gateway; wherein the processor is arranged to determine whether to facilitate indirect communication between the target and source hosts; wherein if it is determined to facilitate indirect communication between the source and target host then the processor is arranged to generate a response that resolves the network layer address of the target host to a link layer address of the primary VLAN gateway; and wherein the communication module is further arranged to send the response to at least the source host.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a system and its environment according to an embodiment of the invention;

FIG. 2 illustrates a process that includes IPv4 host ‘A’ looking for its gateway according to an embodiment of the invention;

FIG. 3 illustrates a process that includes IPv4 host ‘A’ sending packet to host ‘B’ which is on an isolated VLAN according to an embodiment of the invention;

FIG. 4 illustrates a process that includes IPv4 host ‘A’ sending packet to host ‘C’ which is on a different secondary VLAN according to an embodiment of the invention;

FIG. 5 illustrates a process that includes IPv4 host ‘C’ sending packet to host ‘A’ which is on a different secondary VLAN according to an embodiment of the invention;

FIG. 6 illustrates a process that includes IPv4 host ‘C’ sending packet to host ‘D’ which is on the same Community VLAN according to an embodiment of the invention;

FIG. 7 illustrates a process that includes IPv4 host ‘C’ sending packet to host ‘E’ which is on a different Community VLAN according to an embodiment of the invention;

FIG. 8 illustrates a process that includes IPv4 FW MAC address changed and a PVTD notifies hosts according to an embodiment of the invention;

FIG. 9 illustrates a process that includes IPv6 host ‘A’ looking for its gateway according to an embodiment of the invention;

FIG. 10 illustrates a process that includes IPv6 host ‘A’ sending packet to host ‘B’ which is on an isolated VLAN according to an embodiment of the invention;

FIG. 11 illustrates a process that includes IPv6 host ‘A’ sending packet to host ‘C’ which is on a different secondary VLAN according to an embodiment of the invention;

FIG. 12 illustrates a process that includes IPv6 host ‘C’ sending packet to host ‘A’ which is on a different secondary VLAN according to an embodiment of the invention;

FIG. 13 illustrates a process that includes IPv6 host ‘C’ sending packet to host ‘D’ which is on the same Community VLAN according to an embodiment of the invention;

FIG. 14 illustrates a process that includes IPv6 host ‘C’ sending packet to host ‘E’ which is on a different Community VLAN according to an embodiment of the invention;

FIG. 15 illustrates a process that includes IPv6 FW MAC address changed. PVTD notifies hosts according to an embodiment of the invention;

FIG. 16 illustrates a method according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

PVTD refers to a network appliance that is hosted by a computer. It may also refer to the computer itself.

The PVTD may facilitate indirect communication between hosts that belong to one or more secondary VLANs. The PVTD can provide an ARP (Address Resolution Protocol) and/or ICMPv6 ND (IPv6 ICMPv6 Neighbor Discovery) fixup and can monitor private VLAN networks.

The ARP/ICMPv6 ND fixup may allow easy Private VLAN deployment.

The ARP/ICMPv6 ND fixup may eliminate the need to manually configure static routes on hosts.

The implementation of ARP/ICMPv6 ND fixup may keep track of MAC, IPv4/v6 address and Secondary VLAN mappings of hosts. The tracking will allow Firewall admins, network admins and server admins to have a realtime picture of their Private VLAN, and help deploy, log and troubleshoot Private VLAN related issues.

There may be provided a method to reply to ARP requests in a Private VLAN network, which results in inter Secondary VLAN communication or intra Isolated VLAN communication through a Firewall or any other gateway, without any manual configuration on the hosts.

There may be provided a method to reply to IPv6 Neighbor Solicitation requests in a Private VLAN network, which results in inter Secondary VLAN communication or intra Isolated VLAN communication through a Firewall or any other gateway, without any manual configuration on the hosts.

The Private VLAN ARP/ICMPv6 ND fixup may resolve the need to manually configure static routes on hosts when using Private VLANs

A byproduct of the implementation may be a real time mapping of hosts to Secondary VLANs to allow Firewall admins, network admins and servers admins to observe to which secondary VLAN each host belongs, log private VLAN association events and also an additional benefit will provide connectivity matrix between hosts.

List of abbreviations

| Term | Explanation |
|---|---|
| V: | VLAN ID. A 802.1Q tag. |
| SMAC: | The frame's Source Ethernet MAC address. |
| DMAC: | The frame's Destination Ethernet MAC address. |
| OP: | ARP opcode value. Values used are: 1 (REQ—request) |
| | and 2 (RPL—Reply). |
| SPA: | ARP Sender Protocol Address. An IPv4 Address. |
| TPA: | ARP Target Protocol Address. An IPv4 Address. |
| SHA: | ARP Sender Hardware Address. An Ethernet MAC Address. |
| TPA: | ARP Target Hardware Address: An Ethernet MAC Address. |
| MAC(X) | The Ethernet MAC address of host X |
| IP(X) | The IPv4 address of host X |
| DATA | The data inside the IPv4/IPv6 packet. |
| SIP: | IPv4 packet's Source IPv4 Address. |
| DIP: | IPv4 packet's Destination IPv4 Address. |
| SA: | IPv6 packet's Source IPv6 Address |
| DA: | IPv6 packet's Destination IPv6 Address |
| IPv6(X) | The IPv6 Address of host X |
| TYPE: | ICMPv6 Type field. 135 (Neighbor Solicitation) or 136 |
| | (Neighbor Advertisement) |
| SOL(X) | IPv6 Solicited-node Multicast Address of for host X |
| TA: | IPv6 Target Address |
| SLA: | Source Link layer Ethernet MAC Address. An ICMPv6 ND |
| | Option field. |
| TLA: | Target Link layer Ethernet MAC Address. An ICMPv6 ND |
| | Option field. |
| FW: | Firewall |

PVTD is a network appliance which is connected to the Private VLAN network. It includes at least one hardware component or is hosted by a device that has a hardware component.

The PVTD is attached to the network as a switch, which means that all VLANs are trunked to it using 802.1Q tagging.

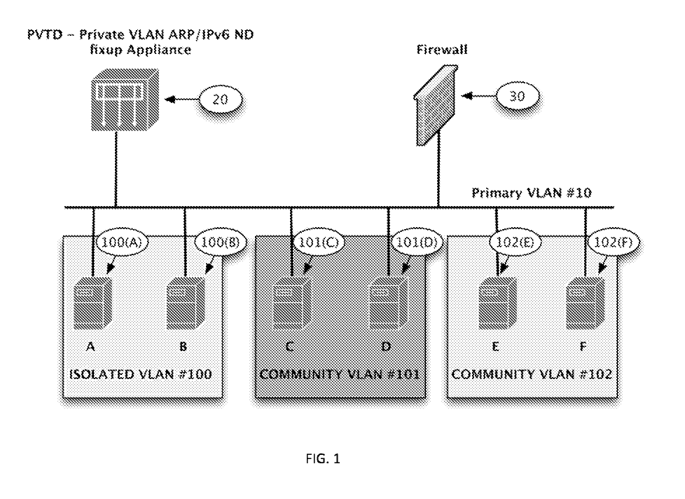

FIG. 1 illustrates a PVTD 20 and its environment according to an embodiment of the invention.

PVTD 20 is coupled or can be regarded as a part of a primary VLAN 10 that also includes primary VLAN gateway (such as firewall 30), and three secondary VLANs—isolated secondary VLAN 100, community secondary VLAN 101 and community secondary VLAN 102.

Isolated secondary VLAN 100 includes host A (100(A)) and host B (100(B)). Community secondary VLAN 101 includes host C (101(C)) and host D (101(D)). Community secondary VLAN 102 includes host E (102(E)) and host F (102(F)).

The firewall (FW) 30 may be connected to a promiscuous port for the primary VLAN.

It is noted that the PVTD 20 can service multiple primary VLANs, that there may be more than a single PVTD per a single primary VLAN, that the number of secondary VLANs and the number of hosts can differ from those illustrated in FIG. 1.

More than one primary VLAN can be coupled to the PVTD.

For redundancy, more than one PVTD can be attached to the network. There is no need for the PVTD appliances to be aware of each other, they can operate in parallel, ignoring any ARP or ICMPv6 ND messages received from each other.

The PVTD can be either physical or a virtual appliance (running as a guest on VMWare ESX host or on any other hypervisor).

PVTD may be configured with the Private VLAN mapping of secondary VLANs, their type and association to a primary VLAN, and for each Primary VLAN PVTD is configured with the IPv4/IPv6 address of gateway, network mask and an IPv4/IPv6 address for its own ARP/ICMPv6 ND operations.

For each Primary VLAN, there could be many IPv6 networks, which all need to be configured in PVTD, with those networks' gateway, network mask and IPv6 address for ICMPv6 ND operations.

An example for Primary VLAN mappings related to FIG. 1:

| Primary VLAN ID | Secondary VLAN ID | Secondary VLAN type |
|---|---|---|
| 10 | 100 | Isolated |
| 10 | 101 | Community |
| 10 | 102 | Community |

PVTD listens to ARP (Address Resolution Protocol) and/or ICMPv6 ND (ICMPv6 Neighbor Discovery) solicitations and builds an internal database with MAC addresses, IPv4/IPv6 addresses and Secondary VLANs of hosts.

If a ARP/ICMPv6 ND solicitation comes from a Primary VLAN, and the SPA (ARP Source Protocol Address) or the IPv6 source address is of the gateway, PVTD learns the MAC address of the gateway from the SHA (ARP Source Hardware Address) or from the SLA (ICMPv6 ND Source Link Address).

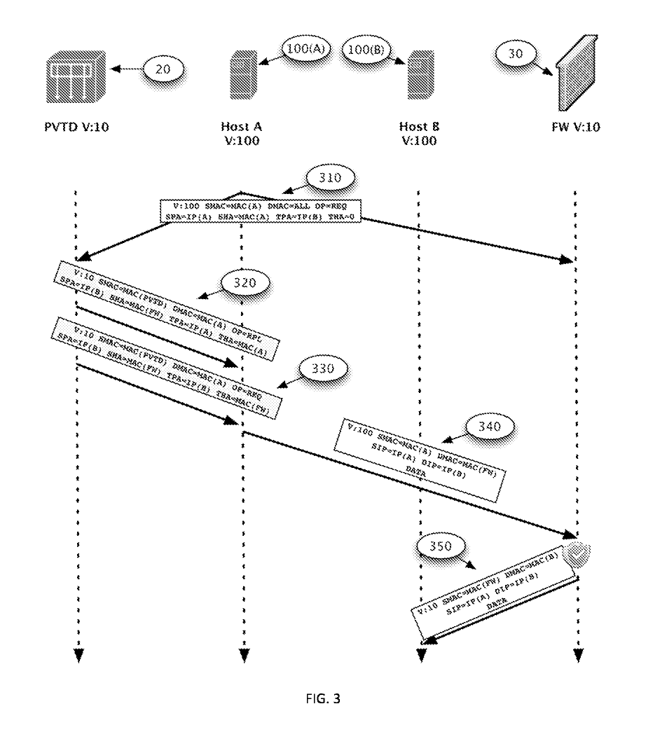

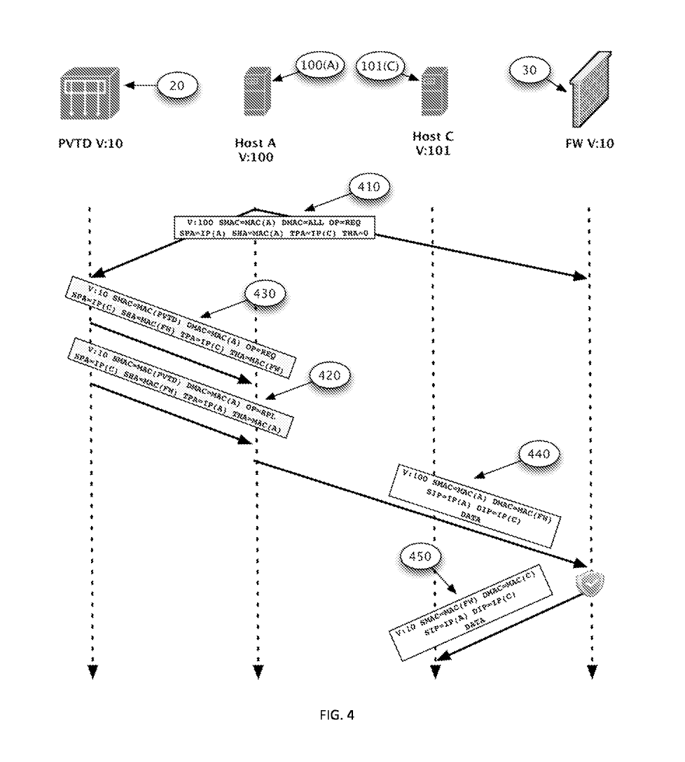

If an ARP request comes from an Isolated VLAN and the TPA is in a secondary VLAN, PVTD sends ARP request and ARP reply, both tagged with the Primary VLAN id and with SPA of the requested TPA (ARP Target Protocol Address) and SHA with the MAC address of the gateway for that network, which is usually a Firewall. This can be seen in FIGS. 3 and 4.

In FIG. 3 the PVTD receives from host A 100(A) a request for resolving the Ethernet address of host B's IPv4 address (request 310—field TPA=IP(B)). The PVTD responds with a ARP response and an ARP request 320 and 330 that maps the IPv4 address of host B (SPA=IP(B)) with the Ethernet address of the firewall (SHA=MAC(FW)). Host A can then communicate with host B by sending a message 340 to the firewall 30 that may send the message 350 to host B. The host is unaware that it is sending the message via the FW.

In FIG. 4 the PVTD receives from host A 100(A) a request for resolving the Ethernet address of host C's IPv4 address (request 410—field TPA=IP(C)). The PVTD responds with a ARP response and an ARP request 420 and 430 that maps the IPv4 address of host C (SPA=IP(C) with the Ethernet address of the firewall (SHA=MAC(FW)). Host A can then communicate with host C by sending a message 440 to the firewall 30 that may send the message 450 to host C. The host is unaware that it is sending the message via the FW.

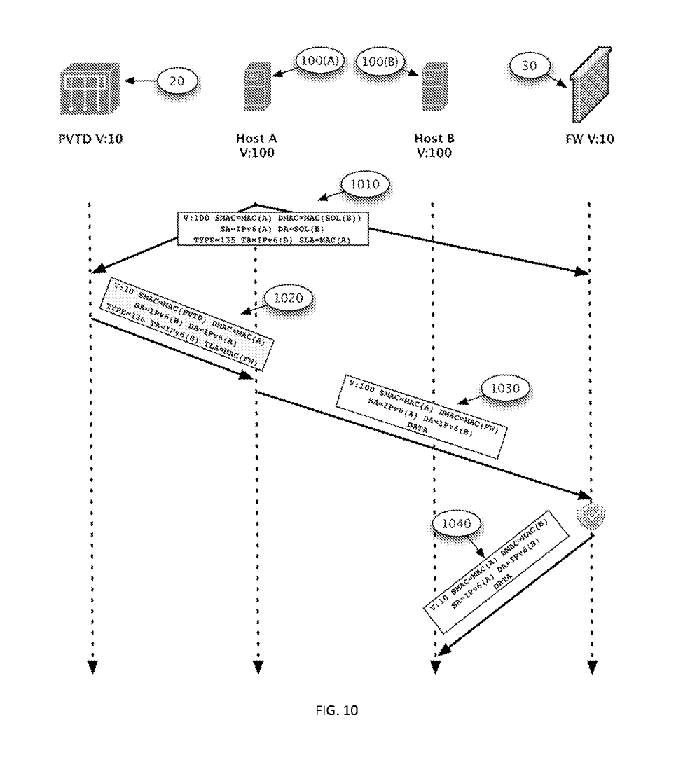

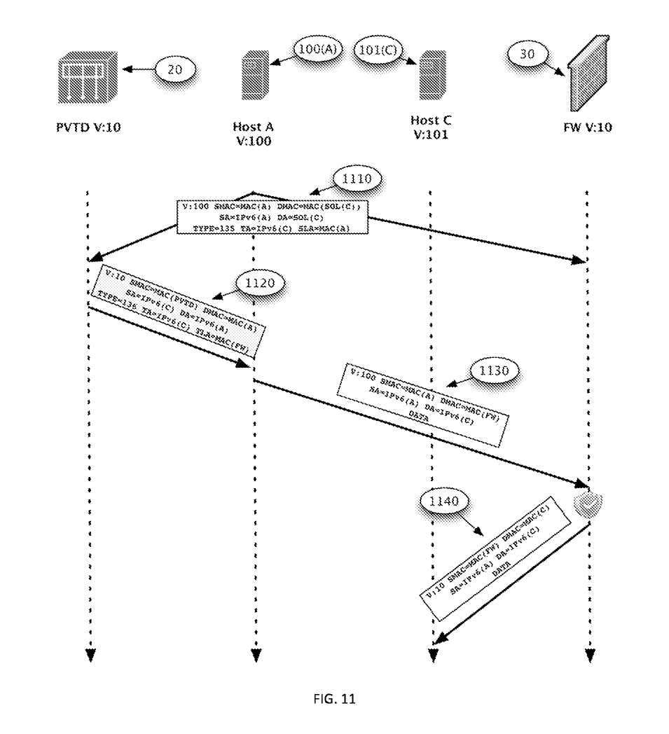

If an ICMPv6 ND solicitation comes from an Isolated VLAN and the TA is in a secondary VLAN, PVTD sends an ICMPv6 ND solicited advertisement tagged with the Primary VLAN id and with TA (ND Target Address) of the requested TA and TLA (ND Target Link Address) with the MAC address of the gateway, which is usually a Firewall. This can be seen on FIGS. 10 and 11.

In FIG. 10 the PVTD receives from host A 100(A) a request 1010 (ICMPv6 ND solicitation) for resolving the Ethernet address of host B's IPv6 address (request 1010—field TA=IPv6(B)). The PVTD responds with a response (ICMPv6 ND solicited advertisement 1020) that maps the IPv6 address of host B (TA=IPv6(B)) with the Ethernet address of the firewall (TLA=MAC(FW)). Host A can then communicate with host B by sending a message 1030 to the firewall 30 that may send the message 1040 to host B. The host is unaware that it is sending the message via the FW.

In FIG. 11 the PVTD receives from host A 110(A) a request 1110 (ICMPv6 ND solicitation) for resolving the Ethernet address of host C's IPv6 address (request 1110—field TA=IPv6(C)). The PVTD responds with a response (ICMPv6 ND solicited advertisement 1120) that maps the IPv6 address of host C (TA=IPv6(C)) with the Ethernet address of the firewall (TLA=MAC(FW)). Host A can then communicate with host C by sending a message 1130 to the firewall 30 that may send the message 1140 to host C. The host is unaware that it is sending the message via the FW.

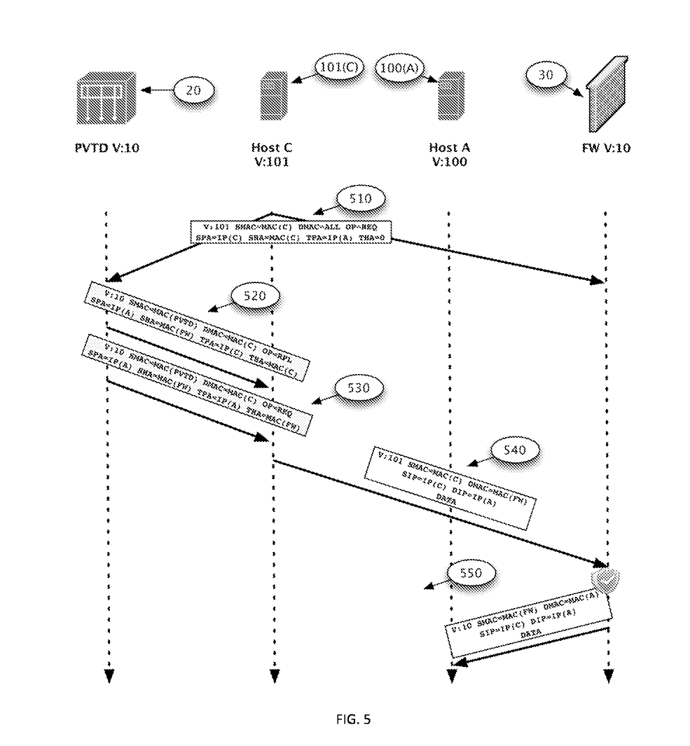

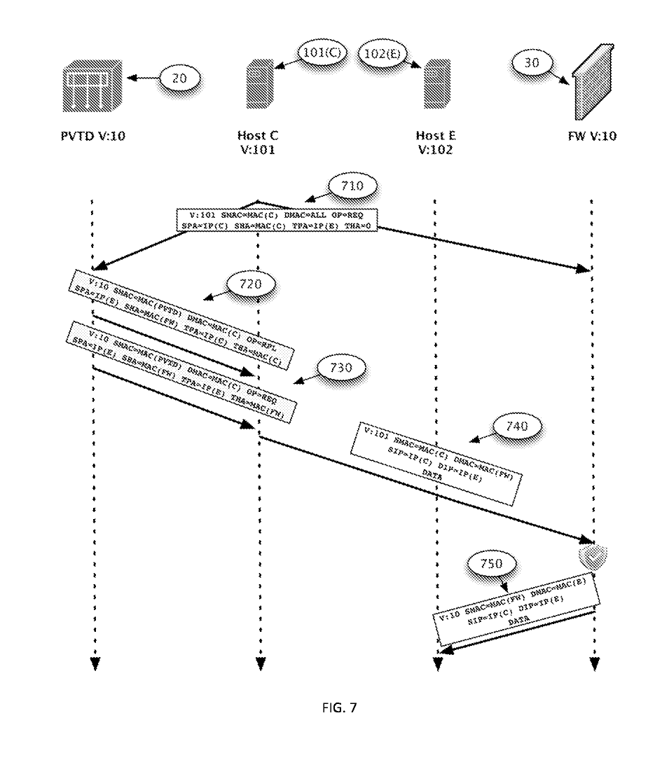

If an ARP request comes from a Community VLAN and the TPA belongs to a different Secondary VLAN, then PVTD sends ARP request and ARP reply, both tagged with the Primary VLAN id and with SPA of the requested TPA and SHA with the MAC address of the gateway, which is usually a Firewall. This can be seen on FIGS. 5 and 7.

In FIG. 5 the PVTD receives from host C 101(C) a request for resolving and the Ethernet address of host A's IPv4 address (request 510—field TPA=IP(A)). The PVTD responds with a ARP response and an ARP request 520 and 530 that maps the IPv4 address of host A (SPA=IP(A) with the Ethernet address of the firewall (SHA=MAC(FW)). Host C can then communicate with host A by sending a message 540 to the firewall 30 that may send the message 550 to host B. The host is unaware that it is sending the message via the FW. It is noted that in the ARP reply the TPA field can be ignored of and its value can be set to values that differ from IP(A).

In FIG. 7 the PVTD receives from host C 101(C) a request for resolving the Ethernet address of host E's IPv4 (request 710—field TPA=IP(E)). The PVTD responds with a ARP response and an ARP request 720 and 730 that maps the IPv4 address of host E (SPA=IP(E) with the Ethernet address of the firewall (SHA=MAC(FW)). Host C can then communicate with host E by sending a message 740 to the firewall 30 that may send the message 750 to host E. The host is unaware that it is sending the message via the FW. It is noted that in the ARP reply the TPA field can be ignored of and its value can be set to values that differ from IP(E). (This is true for all ARP fixups)

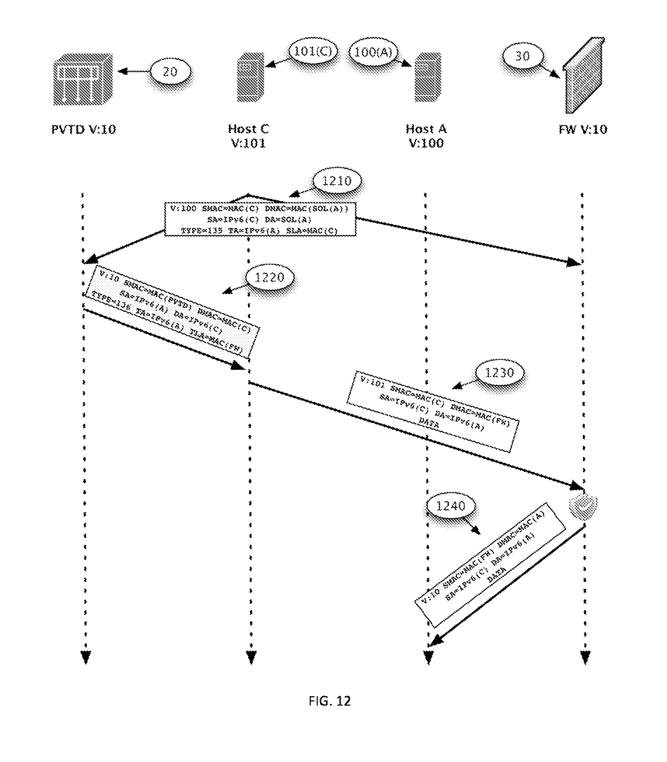

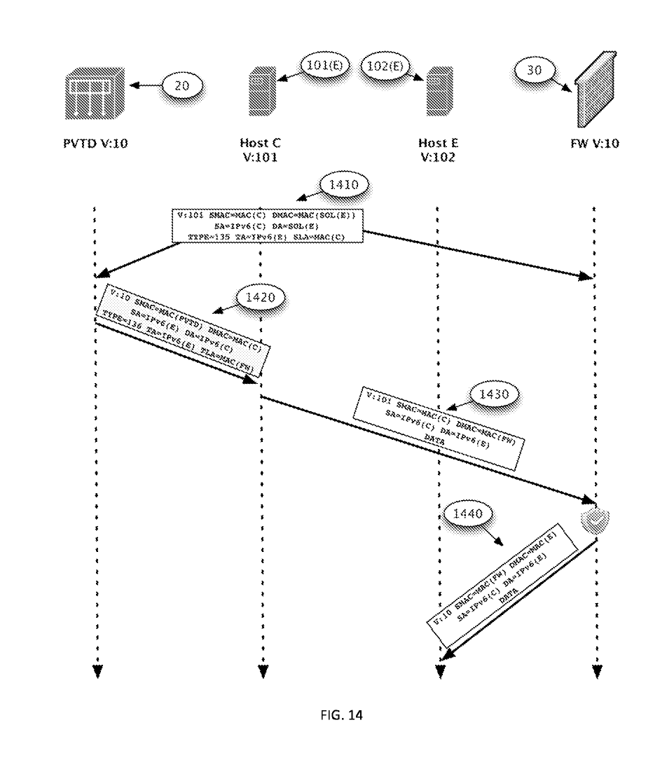

If an ICMPv6 ND solicitation comes from a Community VLAN and the TA belongs to a different Secondary VLAN, then PVTD sends ICMPv6 ND solicited advertisement tagged with the Primary VLAN id and with TA of the requested TA and TLA with the MAC address of the gateway, which is usually a Firewall. This can be seen on FIGS. 12 and 14.

In FIG. 12 the PVTD receives from host C 101(C) a request 1210 (ICMPv6 ND solicitation) for resolving the Ethernet address of host A's IPv6 address (request 1210—field TA=IPv6(A)). The PVTD responds with a response (ICMPv6 ND solicited advertisement 1220) that maps the IPv6 address of host A (TA=IPv6(A)) with the Ethernet address of the firewall (TLA=MAC(FW)). Host C can then communicate with host A by sending a message 1230 to the firewall 30 that may send the message 1240 to host A. The host is unaware that it is sending the message via the FW.

In FIG. 14 the PVTD receives from host C 101(C) a request 1410 (ICMPv6 ND solicitation) for resolving the Ethernet address of host E's IPv6 address (request 1410—field TA=IPv6(E)). The PVTD responds with a response (ICMPv6 ND solicited advertisement 1420) that maps the IPv6 address of host E (TA=IPv6(E)) with the Ethernet address of the firewall (TLA=MAC(FW)). Host C can then communicate with host E by sending a message 1430 to the firewall 30 that may send the message 1440 to host E. The host is unaware that it is sending the message via the FW.

PVTD will not generate an ARP reply, ARP request or an ICMPv6 ND solicited advertisement for a gratuitous ARP or unsolicited ICMPv6 ND advertisement.

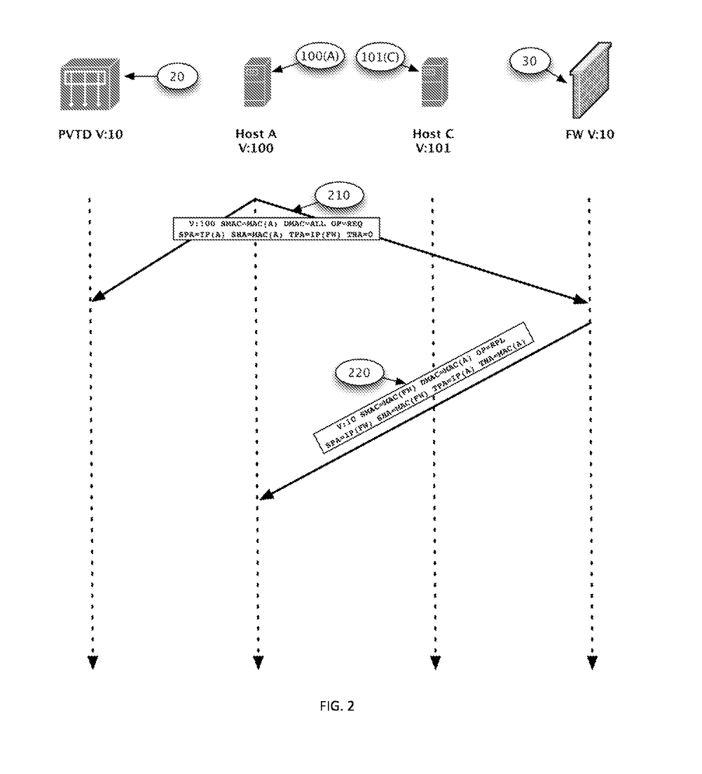

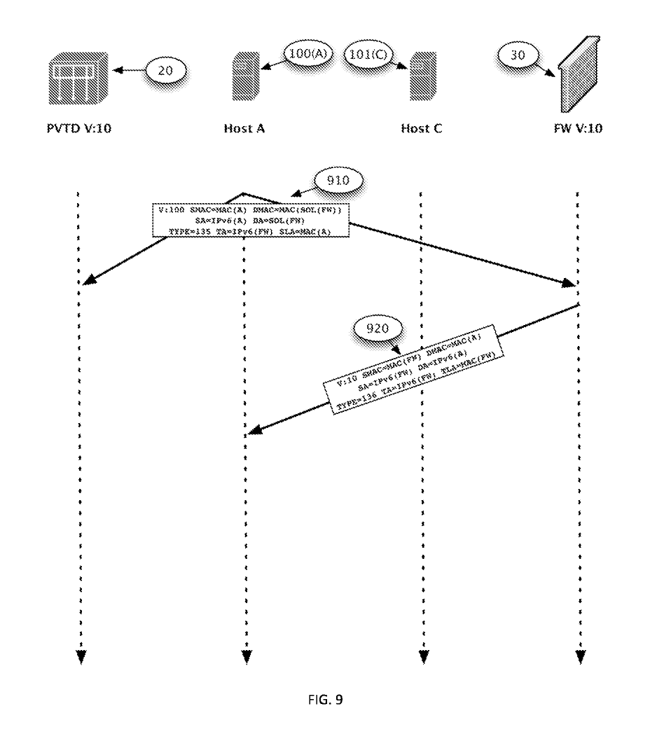

PVTD will not generate an ARP reply, ARP request or an ICMPv6 ND solicited advertisement for any request for a TPA or TA that belongs to the Primary VLAN. See FIGS. 2 and 9. In FIG. 2 the ARP request 210 is identified as a solicited advertisement by including a broadcast field (DMAC=ALL) and a TPA=IP(FW). The firewall 30 sends a response 220. In FIG. 9 the IPv6 solicited advertisement is identified as an IPv6 solicited advertisement by fields DA=SOL(FW).

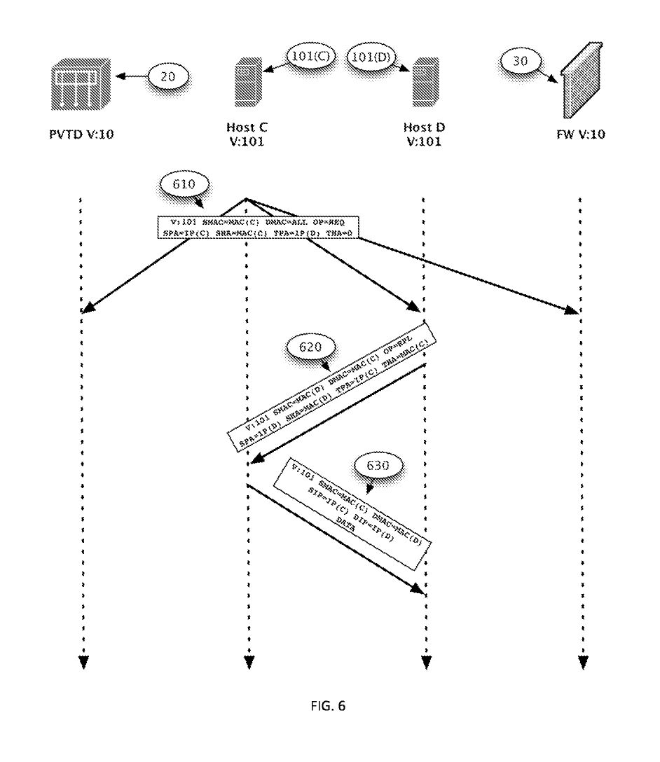

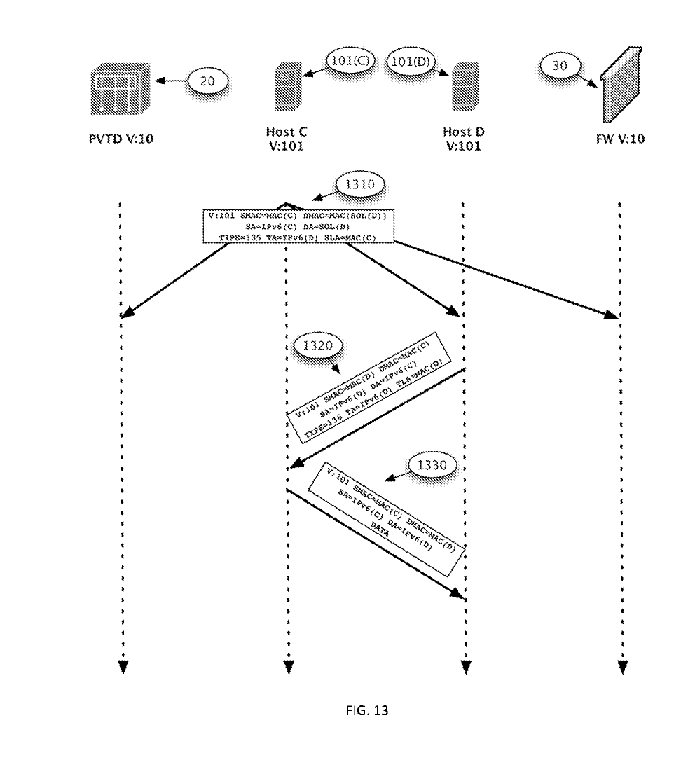

PVTD will not generate an ARP reply or ICMPv6 ND solicited advertisement for any request from a Community VLAN for a TPA or TA belonging to the same Community VLAN. The PVTD detects (request 610 of FIG. 6 and request 1310 of FIG. 13) that the source host is C (fieldSHA=MAC(C)) and that the target host is D (field TPA=IP(D) of request 610 and field TA=IPv6(D)) and based upon the inclusion of both hosts C and D in community secondary VLAN 101 the PVTD decides not to respond to the ARP request.

If a PVTD does not have the requested ARP TPA in its database, then PVTD will send an ARP request to resolve that address. The request will be tagged with the Primary VLAN ID.

If a PVTD does not have the requested ICMPv6 ND TA in its database, then PVTD will send an ICMPv6 ND solicitation to resolve that address. The request will be tagged with the Primary VLAN id.

For all ARP request generated by this innovation with SHA of the gateway (usually a Firewall), THA (ARP Target Host Address) can be equal either to the SHA, to 0xFFFFFFFFFFFF (all ones) or to 0x000000000000 (all zeros). All variations are used to make sure these frames are not dropped due to sanity checks by hosts.

For all ARP replies generated by this innovation with SHA of the gateway (usually a Firewall) the destination MAC address is the MAC address of the host which sent an ARP request for the SPA inside the reply.

For all ICMPv6 ND Neighbor Advertisements generated by this innovation with TLA of the gateway (usually a Firewall) the destination MAC address is the MAC address of the host which sent an ICMPv6 ND Neighbor Solicitation for the TA inside the ICMPv6 ND Neighbor Advertisement.

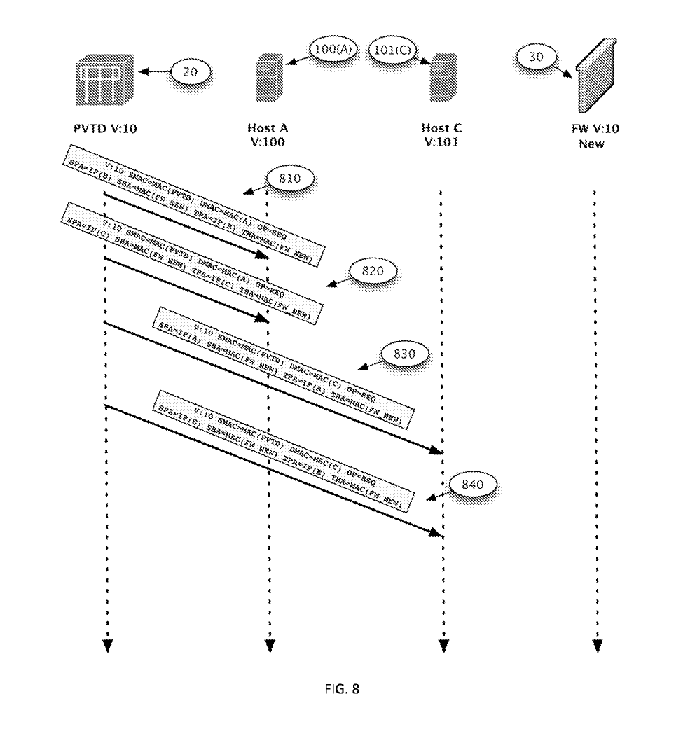

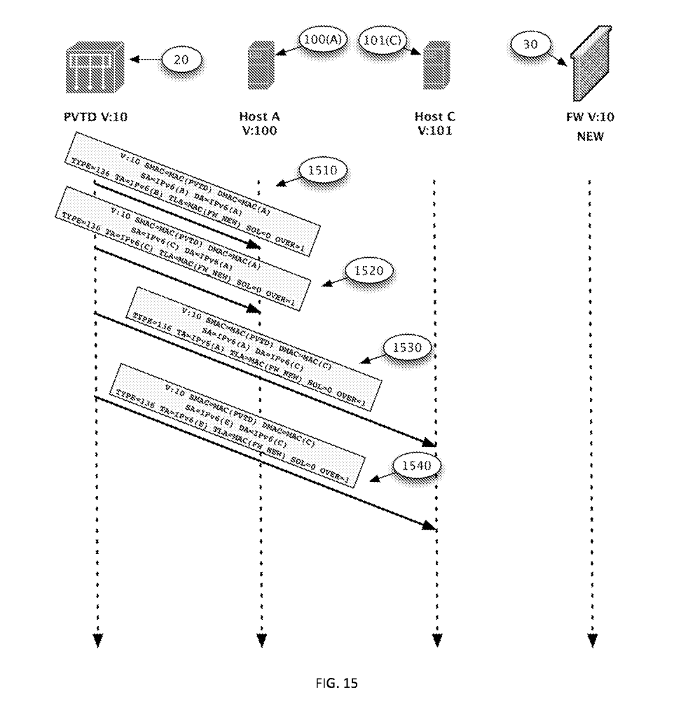

Listening to ARP requests/ICMPv6 ND Neighbor Solicitations, PVTD will track all the connections between hosts, and in the event of a gateway MAC change, it will notify the hosts of the gateway MAC change using gratuitous ARP requests or unsolicited ICMPv6 ND advertisement packets with overwrite flag set to one. These frames/packets will be tagged with the Primary VLAN id. This can be seen on FIGS. 8 and 15. FIG. 8 illustrates the PVTD 20 as sending ARP requests 810, 820, 830 and 840 to host A and to host C. The new address of firewall 30 is included in field SHA=MAC(FW NEW). For IPv6, setting the override flag to zero will be slower, as the host will first try to resolve the address and only then they will use the new MAC address. The same applied to FIG. 15.

PVTD will send an alarm (syslog) for mis-configured hosts (unknown VLAN tag, SPA/IPv6 Source address of the gateway coming from secondary VLAN, hosts looking for TPA or TA which do not belong to the Primary VLAN subnet, SPA/IPv6 source address which do not belong to the Primary VLAN subnet) or any host database event (Add, remove and change) to allow external software to monitor the private VLAN network.

Is order not to overwhelm the logging facilities, PVTD will use logging suppression based on a hash of the SPA or source IPv6 address.

The system and method can be used by computer networks which currently are using Private VLANs to help them:
a. Eliminate the need to manually configure static routes on hosts for inter Secondary VLAN communication or for intra Isolate VLAN communication.
b. Allow all admins (Firewall, network and servers) to see the mapping of hosts to Secondary VLANs in realtime, helping them to deploy new hosts and to troubleshoot problems related to Private VLANs.
c. Allow logging all changes in hosts mappings to Secondary VLANs.
d. Allows easier deployments of new Private VLAN networks, where previously were not deployed due to the need to manually configure static routes on hosts and not being able to see in realtime mappings of hosts to Secondary VLANs.

### Example of Networks which can Benefit from Private VLANs

e. Hosting/Cloud services, allows them to separate customers without the need to allocate one or multiple IPv4/IPv6 segment to each customer.
f. VDI (Virtual Desktop Infrastructure) deployments, which is like regular hosting/cloud services but with many more hosts.
g. Extranet networks, where there is a need to separate business partners and separate applications.
h. External or internal secure networks, where granular separation between hosts is needed.
i. Implementing network segregation for existing networks without IPv4/IPv6 renumbering or movement to other segments.

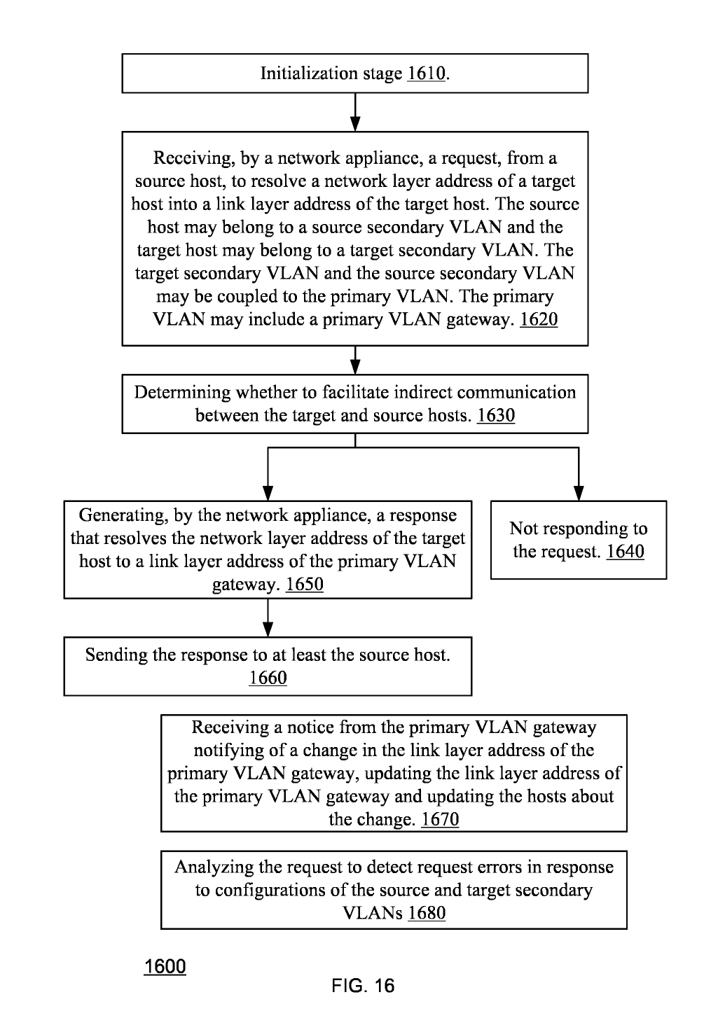

FIG. 16 illustrates method 1600 according to an embodiment of the invention.

Method 1600 may start by initialization stage 1610.

Stage 1610 may include learning a mapping between network layer address and the link layer address of the primary VLAN gateway.

Stage 1610 may include learning a mapping between network layer addresses and link layer addresses of hosts of the source and target secondary VLANs. The learning can include monitoring requests transmitted over the network. Stage 1610 may include sending requests to hosts in order to identify hosts that have certain network layer addresses.

It is noted that stage 1610 can be, at least partially executed during the execution of other stages of method 1600. For example, learning the identity of a host that has a certain network layer address (that may appear in a request for address resolution) can be triggered by a reception of that request.

For example, stage 1620 may be followed by ignoring requests (received during stage 1620) to resolve the network layer address of the target host into the link layer addresses of the target host until a reception of the identifying response.

It is also noted that network layer and link layer addresses can appear in various types of messages and that stage 1610 can include monitoring such messages.

Stage 1610 may be followed by stage 1620 of receiving, by a network appliance, a request, from a source host, to resolve a network layer address of a target host into a link layer address of the target host.

The source host may belong to a source secondary VLAN and the target host may belong to a target secondary VLAN. The target secondary VLAN and the source secondary VLAN may be coupled to the primary VLAN. The primary VLAN may include a primary VLAN gateway.

Stage 1620 may be followed by stage 1630 of determining whether to facilitate indirect communication between the target and source hosts.

Stage 1630 may be responsive to the configuration of the networks—especially to the type of each secondary VLAN (community, isolated), its association to a Primary VLAN and to policy considerations (for example—whether to allow indirect communications between hosts that can communicate directly with each other).

Stage 1630 may include determining to facilitate indirect connection between hosts that belong to the same isolated VLAN.

The source and target hosts may belong to the same secondary VLAN and stage 1630 may include determining not to generate the response if that secondary VLAN is configured as a community VLAN

Stage 1630 may include determining not to generate the response if the source and target hosts are allowed to directly communicate with each other.

Stage 1630 may include determining to facilitate indirect communication between the source and target hosts if at least one of the primary and secondary hosts is configured as a community VLAN or as an isolated VLAN

If it is determined not to facilitate indirect communication then stage 1630 may be followed by stage 1640 of not responding to the request.

If it is determined to facilitate indirect communication between the source and target host then stage 1630 may be followed by stages 1650 and 1660.

Stage 1650 may include generating, by the network appliance, a response that resolves the network layer address of the target host to a link layer address of the primary VLAN gateway.

Stage 1650 may also include generating an updated request that comprises the network layer address of the target host and the link layer address of the primary VLAN gateway; sending the updated request to at least the source host. Non-limiting examples of such updated requests appear in FIGS. 3, 4, 5 and 7.

Stage 1660 may include sending the response to at least the source host. If an updated request is generated it may also be sent to, at least, the source host.

The source and the target hosts can belong to the same secondary VLAN (and then the source secondary VLAN is the target secondary VLAN) but may belong to different secondary VLANs (and then the source secondary VLAN differ from the target secondary VLAN).

Method 1600 may also include stage 1670 of receiving a notice from the primary VLAN gateway notifying of a change in the link layer address of the primary VLAN gateway, updating the link layer address of the primary VLAN gateway and updating the hosts about the change. A non-limiting example is provided in FIGS. 8 and 15. In FIG. 8 the PVTD sends ARP requests 810 and 820 to host A with the new address SHA=MAC(FW NEW) and THA=MAC(FW NEW) and sends ARP requests 830 and 840 to host C with the new address SHA=MAC(FW NEW) and THA=MAC(FW NEW).

In FIG. 15 the PVTD sends ICMPv6 ND unsolicited neighbor advertisement messages 1510 and 1520 to host C with the new address TLA=MAC(FW NEW) and sends ICMPv6 ND solicitation messages 530 and 1540 to host C with the new address TLA=MAC(FW NEW).

Method 1600 may also include stage 1680 of analyzing the request to detect request errors in response to configurations of the source and target secondary VLANs.

It is contemplated that any optional feature of the inventive variations described may be set forth and claimed independently, or in combination with any one or more of the features described herein. Reference to a singular item, includes the possibility that there is a plurality of the same items present.

More specifically, as used herein and in the appended claims, the singular forms “a,” “an,” “said,” and “the” include plural referents unless specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the claims shall allow for the inclusion of any additional element irrespective of whether a given number of elements are enumerated in the claim, or the addition of a feature could be regarded as transforming the nature of an element set forth in the claims. Except as specifically defined herein, all technical and scientific terms used herein are to be given as broad a commonly understood meaning as possible while maintaining claim validity. The breadth of the present invention is not to be limited to the examples provided and/or the subject specification, but rather only by the scope of the claim language.

Use of the term “invention” herein is not intended to limit the scope of the claims in any manner. Rather it should be recognized that the “invention” includes the many variations explicitly or implicitly described herein, including those variations that would be obvious to one of ordinary skill in the art upon reading the present specification. Further, it is not intended that any section of this specification (e.g., the Summary, Detailed Description, Abstract, Field of the Invention, etc.) be accorded special significance in describing the invention relative to another or the claims. All references cited are incorporated by reference in their entirety. Although the foregoing invention has been described in detail for purposes of clarity of understanding, it is contemplated that certain modifications may be practiced within the scope of the appended claims.

The invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for facilitating communication between hosts coupled to a primary virtual local area network (VLAN), the method comprises:
receiving, by a network appliance, a request, from a source host, to resolve a network layer address of a target host into a link layer address of the target host;
wherein the source host belongs to a source secondary VLAN and wherein the target host belongs to a target secondary VLAN;
wherein the target secondary VLAN and the source secondary VLAN are coupled to the primary VLAN;
wherein the primary VLAN comprises a primary VLAN gateway;
determining whether to facilitate indirect communication between the target and source hosts;
wherein if it is determined to facilitate indirect communication between the source and target host then:
generating, by the network appliance, a response that resolves the network layer address of the target host to a link layer address of the primary VLAN gateway; and
sending the response to at least the source host.

2. The method according to claim 1, wherein the source secondary VLAN is the target secondary VLAN.

3. The method according to claim 2, wherein the source secondary VLAN is configured as an isolated VLAN and wherein the method comprises determining to facilitate indirect communication between the source and target hosts.

4. The method according to claim 2, wherein the source secondary VLAN is configured as a community VLAN and wherein the method comprises determining not to generate the response.

5. The method according to claim 1, comprising determining not to generate the response if the source and target hosts are allowed to directly communicate with each other.

6. The method according to claim 1, wherein the source secondary VLAN differs from the target secondary VLAN.

7. The method according to claim 6, comprising determining to facilitate indirect communication between the source and target hosts if at least one of the primary and secondary hosts is configured as a community VLAN or as an isolated VLAN.

8. The method according to claim 1, comprising learning a mapping between network layer address and the link layer address of the primary VLAN gateway.

9. The method according to claim 1, comprising learning a mapping between network layer addresses and link layer addresses of hosts and the host's association to a secondary VLAN.

10. The method according to claim 1, wherein if it is determined to facilitate indirect communication between the source and target host then the method further comprises generating an updated request that comprises the network layer address of the target host and the link layer address of the primary VLAN gateway; sending the updated request to at least the source host.

11. The method according to claim 1, comprising receiving a notice from the primary VLAN gateway notifying of a change in the link layer address of the primary VLAN gateway; updating the link layer address of the primary VLAN gateway and determining not to send a response to the notice.

12. The method according to claim 1, comprising sending a request to identify the target host, if the network application is unaware of the identity of the target host; and awaiting to receive an identifying response from the target host before determining whether to facilitate indirect communication between the target and source hosts.

13. The method according to claim 12, comprising ignoring requests to resolve the network layer address of the target host into the link layer addresses of the target host until a reception of the identifying response.

14. The method according to claim 1, comprising analyzing the request to detect request errors in response to configurations of the source and target secondary VLANs.

15. The method according to claim 1, wherein the request is address resolution protocol (ARP) compliant.

16. The method according to claim 1, wherein the request is network discovery protocol (ICMPv6 ND) compliant.

17. The method according to claim 1, wherein the network layer address of the target host is internet protocol compliant.

18. The method according to claim 1, wherein the link layer address of the target host is Ethernet compliant.

19. A non-transitory computer readable medium that stores instructions for:
receiving, by a network appliance, a request, from a source host, to resolve a network layer address of a target host into a link layer address of the target host;
wherein the source host belongs to a source secondary virtual local area network (VLAN) and wherein the target host belongs to a target secondary VLAN;
wherein the target secondary VLAN and the source secondary VLAN are coupled to a primary VLAN;
wherein the primary VLAN comprises a primary VLAN gateway;
determining whether to facilitate indirect communication between the target and source hosts;
wherein if it is determined to facilitate indirect communication between the source and target host then:
generating, by the network appliance, a response that resolves the network layer address of the target host to a link layer address of the primary VLAN gateway; and
sending the response to at least the source host.

20. A computerized system, comprising a communication module and a processor;
wherein the communication module is arranged to receive a request, from a source host, to resolve a network layer address of a target host into a link layer address of the target host; wherein the source host belongs to a source secondary virtual local area network (VLAN) and wherein the target host belongs to a target secondary VLAN; wherein the target secondary VLAN and the source secondary VLAN are coupled to a primary VLAN; wherein the primary VLAN comprises a primary VLAN gateway;
wherein the processor is arranged to determine whether to facilitate indirect communication between the target and source hosts; wherein if it is determined to facilitate indirect communication between the source and target host then the processor is arranged to generate a response that resolves the network layer address of the target host to a link layer address of the primary VLAN gateway; and wherein the communication module is further arranged to send the response to at least the source host.
